(19) United States
(12) Patent Application Publication
(10) Pub. No.: US 2016/0167620 A1
(43) Pub. Date: Jun. 16, 2016

(54) VEHICLE CONTROL SYSTEM AND METHOD

(71) Applicant: Barry John Bryar, Sunshine West (AU)

(72) Inventor: Barry John Bryar, Sunshine West (AU)

(21) Appl. No.: 14/941,704

(22) Filed: Nov. 16, 2015

Related U.S. Application Data
(63) Continuation of application No. 13/980,439, filed on Oct. 4, 2013, now abandoned.

(30) Foreign Application Priority Data
Jan. 18, 2011 (AU) 2011900147

(51) Int. Cl. B60R 25/08; B60T 13/68; B60T 13/38; B60T 13/26

(52) U.S. Cl. CPC B60R 25/08; B60T 13/26; B60T 13/683; B60T 13/385

(57) ABSTRACT

A control system for a vehicle (10) having an air braking system includes a supply line (13) for receiving a supply of compressed air for the air braking system. One or more brake members (19) are provided in fluid communication with the supply line (13) and controllable such that upon receipt of compressed air, the brake members (19) become disengaged to facilitate movement of the vehicle (10). Upon removal of the compressed air, the brake members (19) become engaged to prevent movement of the vehicle (10). An isolator device (20) is positionable within the supply line (13) upstream of the brake members (19) and is controllable to operate in a first state wherein the compressed air flows along a supply line (16) and a second state wherein the compressed air is prevented from flowing along the supply line (16) to the brake members (19).

### CROSS-REFERENCE TO RELATED APPLICATIONS

This application is a continuation of the co-pending U.S. patent application Ser. No. 13/980,439, filed on Oct. 4, 2013 as a Section 371 of International Application No. PCT/AU2012/000007, filed Jan. 8, 2012, which was published in the English language on Jul. 26, 2012, under International Publication No. WO 2012/097400 A1, and the disclosure of which is incorporated herein by reference.

The present application claims priority from Australian Provisional Patent Application No. 2011900147 filed on Jan. 18, 2011, the contents of which are incorporated herein by reference.

### FIELD OF THE INVENTION

The present invention relates to a vehicle control system and method, and in particular, to a vehicle control system and method to address theft and unauthorized access of vehicles that employ a pneumatic braking system.

### BACKGROUND OF THE INVENTION

This section provides background information related to the present disclosure which is not necessarily prior art.

Pneumatic or compressed air braking systems are employed on a variety of different types of vehicles, typically heavy vehicles, such as trucks, buses, trailers and semi-trailers. Such a braking system generally comprises an engine-driven air compressor that generates a source of compressed air and one or more storage tanks located on the vehicle for storing the compressed air for use by the braking system of the vehicle. Such braking systems generally comprise service brakes and parking brakes and separate pneumatic circuits are generally provided for delivering compressed air to the brakes.

Parking brakes are typically activated when the vehicle is stationary, whilst the service brakes are typically employed for slowing or stopping the vehicle when in motion. In this regard, parking brakes typically employ a disc or drum brake arrangement that is maintained in a default applied position through a spring pressure. In order to release the parking brakes, a supply of pressurized air is supplied to the spring to release the spring pressure, thus enabling the vehicle to move. In this regard, when a vehicle is parked, the brake releases the pressurized air in the parking brake lines, typically between the source of pressurized air and the brakes, thereby activating the parking brake.

While such a conventional parking brake system provides an effective safety function such that the air brake system is maintained when the compressed air supply line to the parking brakes is exhausted, the fact that the parking brakes can be simply deactivated by connection to any tractor's compressed air system makes security problematic. This is particularly the case where a trailer with its cargo is parked (with or without the tractor), as it is susceptible to theft by the simple means of pressurizing the supply line to release the park brakes, which may be achieved by simply connecting a tractor, truck or the like to the trailer.

To address this problem, a trailer isolator assembly has been proposed, as disclosed in the present Applicant's International PCT Patent Application No. PCT/AU2004/001730, published as International Publication No. WO 2005/056352 A1, the contents of which are incorporated herein by reference. The trailer isolator assembly described therein is in the form of a mechanically operated valve incorporated into a trailer braking system. The mechanical valve is physically activated by a user to prevent a trailer, the brakes of which are locked upon disconnection of the trailer from a compressed air source (such as from a prime mover), from being moved by simply connecting it to another prime mover, and providing a compressed air supply thereto. In this arrangement, a mechanical valve is located in the compressed air supply line and, whilst the valve is closed, air from an external source cannot pass through this line to activate or unlock, the braking system.

Whilst above referenced trailer isolator assembly has been proven effective in isolating a trailer to prevent theft, the system requires manual handling to activate and deactivate the isolator assembly. Hence, should a user inadvertently forget to activate the mechanical valve when leaving a trailer, the device will not be activated.

As with the above referenced device, other types of locking valves and systems have also been proposed to address this problem. However, an issue with such proposed systems is that they typically only function to prevent the air supply line from controlling the vehicle park brakes. Whilst diverting or otherwise blocking the air supply line from supplying a stream of compressed air, this will ensure that pressurized air will not pass through the locking valve or system. However, by employing such an arrangement, the air line between the locking valve or system and the park brake control valve will typically also become blocked, thus potentially compromising the safety of the vehicle. Vehicle safety becomes compromised because in this region of the air supply circuit, namely the air line between the locking valve and the park brake control valve, it is possible for the park brake valve to experience leakage such that compressed air from a connected compressed air storage tank or the like located within the circuit can be leaked back into the supply air line. This can cause the brakes to be released inadvertently and greatly increases the potential for the vehicle to shift and become a safety hazard.

Thus, there is a need to provide a system and method for controlling a vehicle having pneumatic air brakes that is automatically actuated and which can be initiated without compromising the vehicles safety while locking the brake system.

The above references to and descriptions of prior proposals or products are not intended to be, and are not to be construed as, statements or admissions of common general knowledge in the art. In particular, the above prior art discussion does not relate to what is commonly or well known by the person skilled in the art, but assists in the understanding of the inventive step of the present invention of which the identification of pertinent prior art proposals is but one part.

### BRIEF SUMMARY OF THE INVENTION

Accordingly, in a first aspect, there is provided a control system for a vehicle having an air braking system comprising: a supply line for receiving a supply of compressed air for use in the air braking system; one or more brake members in fluid communication with the supply line and controllable such that upon receipt of a supply of compressed air the one or more brake members become disengaged so as to facilitate movement of the vehicle and upon removal of the supply of compressed air the one or more brake members become engaged so as to prevent movement of the vehicle; and an isolator device positionable within the supply line so as to be located upstream of said one or more brake members, the isolator device being controllable to operate in at least two states, a first state wherein the compressed air is permitted to flow along said supply line to the one or more brake members and a second state wherein the compressed air is prevented from flowing along said supply line to the one or more brake members; wherein when said isolator device is in the second state, any compressed air present in the supply line downstream of the isolator device but upstream of the one or more brake members is exhausted therefrom.

In one embodiment, the isolator device comprises an inlet connectable to the supply line so as to be in fluid communication with the supply of compressed air, and an outlet in fluid communication with the one or more brake members.

The isolator device may comprise a pneumatic manifold that is controllable to place said isolator device in said first or second state. The pneumatic manifold may comprise an isolator valve that is movable between an open and a closed position. In a preferred embodiment, when the isolator valve is in the open position, the isolator device is in the first state and compressed air is able to pass therethrough from the inlet to the supply line downstream of the isolator device, and when the isolator valve is in the closed position the isolator device is in the second state and compressed air is prevented from passing therethrough directly from the inlet.

The pneumatic manifold may further comprise a pressure proportioning valve in fluid communication with the isolator valve. The pressure proportioning valve may be controllable to facilitate exhausting or venting of pressurized air from the isolator device. The pressure proportioning valve may be controllable so as to be placed in an open state that facilitates flow of pressurized air therethrough, and a closed state that facilitates exhausting or venting of pressurized air therefrom.

The pneumatic manifold may further comprise a pressure switch in fluid communication with the outlet of the isolator device to facilitate monitoring of the pressure of air present in the supply line downstream of the isolator device.

In a preferred embodiment, when the isolator device is in the second state and the control switch detects the presence of pressurized air in the supply line downstream of the isolator device, the pressure proportioning valve is placed in a closed state to facilitate exhausting or venting of said pressurized air therefrom through said isolator valve. In this arrangement, when the isolator device is in the second state the pressure proportioning valve may be controllable between and open and a closed position to cater for any build-up of pressurized air in the supply line downstream of the isolator device as detected by the control switch.

Each of the control switch, pressure proportioning valve and the isolator valve of the pneumatic manifold may be controllable by a programmable controller. The programmable controller may be a computer device housed within the isolator device.

In one embodiment, the vehicle may comprise a tractor and a detachable trailer, wherein the supply of compressed air is provided by an air compressor provided on the tractor. In such an arrangement, the one or more brake members may be park brakes provided on the detachable trailer.

According to a second aspect, there is provided an isolator device for a vehicle having an air braking system comprising: an inlet for receiving a supply of compressed air; an outlet for delivering a supply of compressed air to an air braking system positioned downstream of the isolator device; a pneumatic manifold controllable so as to regulate the supply of compressed air to air braking system positioned downstream of the isolator device and from the air braking system downstream of the isolator device; and a controller for controlling the pneumatic manifold.

According to a third aspect, there is provided a method of controlling an air braking system of a vehicle comprising: detecting the vehicle being placed in a parked condition; activating an isolator device to prevent unauthorized delivery of compressed air to the air braking system of the vehicle to release brakes of the air braking system; monitoring the air braking system to detect the presence of compressed air therein; and deactivating the isolator device upon receipt of an authorized signal.

The step of detecting the vehicle being placed in a parked condition may comprise sensing the state of the vehicle park brakes and generating a signal when the park brakes of the vehicle have been activated by a driver of the vehicle.

The step of activating the isolator device may comprise placing the isolator valve of the isolator device in a closed position.

The step of monitoring the air braking system may comprise detecting the state of the pressure switch of the isolator device and upon the pressure switch detecting the presence of compressed air in the air braking system placing the pressure proportioning valve in a closed state to facilitate exhausting or venting of said compressed air therefrom through said isolator valve.

The step of deactivating the isolator device may comprise receiving a deactivation signal from a source and checking the authenticity of the deactivation signal from an authentification source. The source of the deactivation signal may be a RF transmitter or remote control transmitter carried by an authorized user of the vehicle. The authenticity of the deactivation signal may be checked by reference to a database of authentic signals stored internally of the isolator device or accessed by the isolator device remotely.

### BRIEF DESCRIPTION OF THE SEVERAL VIEWS OF THE DRAWING

The invention may be better understood from the following non-limiting description of preferred embodiments, in which:

FIG. 1 is a side view of a vehicle employing the vehicle control system in accordance with an embodiment of the present invention;

FIG. 2 is a plan view showing a simplified version of a vehicle air brake system employing a control system according to an embodiment of the present invention;

FIG. 3 shows a system diagram of an embodiment of an isolator assembly for use in the control system according to an embodiment of the present invention;

FIG. 4 shows an embodiment of the isolator assembly of FIG. 3 in an open state;

FIG. 5 shows an embodiment of the isolator assembly of FIG. 3 in a closed state; and

FIG. 6 shows an embodiment of the isolator assembly of FIG. 3 in an operational state for slowing down a moving vehicle.

### DETAILED DESCRIPTION OF THE INVENTION

Preferred features of the present invention will now be described with particular reference to the accompanying drawings. However, it is to be understood that the features illustrated in and described with reference to the drawings are not to be construed as limiting on the scope of the invention.

The present invention will be described below in relation to its application to a conventional semi-trailer vehicle or articulated truck. However, it will be appreciated that the present invention can be equally applicable for use in any vehicle that employs an air braking system, whether the vehicle is used to tow a trailer or not.

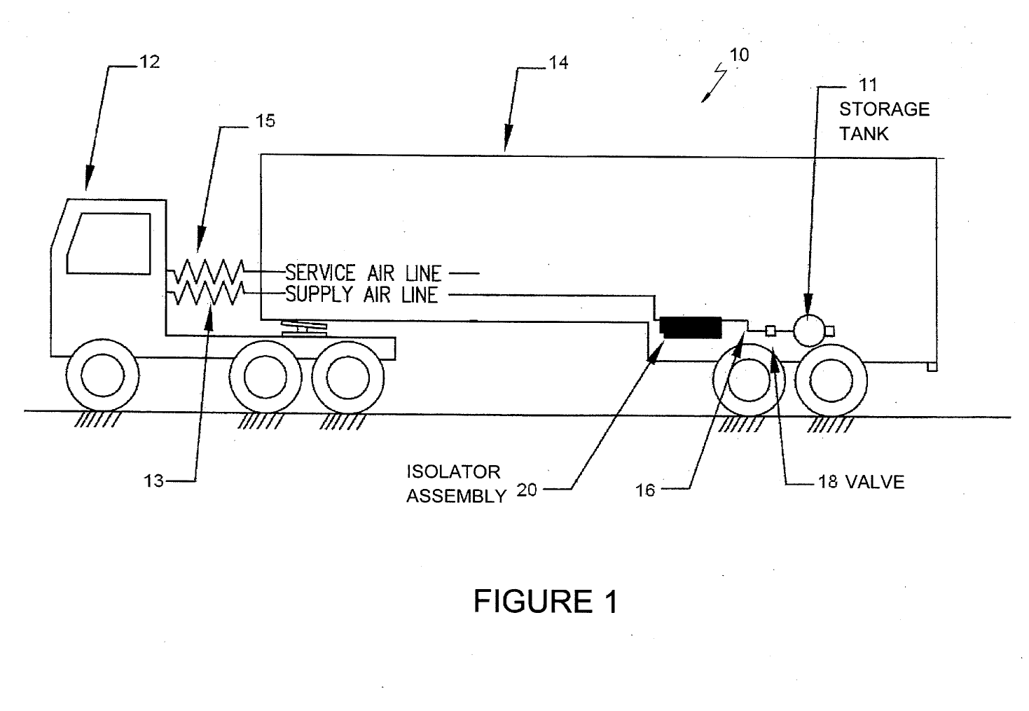

Referring to FIG. 1, a vehicle 10 employing one embodiment of the present invention is shown. The vehicle 10 comprises a tractor 12 that is connected to pull a trailer 14. In the embodiment as shown, the trailer 14 is of a conventional design, typically used to store and transport cargo; however, other designs of trailers 14 are also envisaged.

The vehicle 10 employs a standard air brake system comprising two pneumatic circuits 13, 15. Pneumatic circuit 13 supplies compressed air for use in controlling the operation of the park brake of the trailer 14, for when the vehicle 10 is stationary. Pneumatic circuit 15 supplies compressed air for use in controlling the service brakes of the trailer 14, namely those brakes that are used for slowing or stopping the moving vehicle 10.

The tractor 12, when connected to the trailer 14, supplies the two circuits 13, 15 with a source of compressed air in the form of two suzi-coiled air lines. When the vehicle 10 is in a parked position or the trailer 14 is disconnected from the tractor 12, the park brake line 13 to the trailer is typically vented or exhausted to atmosphere. This ensures that the park brakes 19 of the trailer 14 remain fully applied to prevent movement of the trailer 14. The park brakes 19 are typically in the form of a disc or drum brake arrangement that are designed to be held or maintained in a braking position by a spring arrangement. Hence the park brakes 19 are typically biased to be in the ‘on’ position, by way of a constant spring force.

A park brake control valve 18 is provided to pneumatically control the park brakes 19 such that the spring force present in the park brakes 19 can be controlled to apply and release the brakes 19 as desired. When the park brake control valve 18 is supplied with pressurized air, the spring pressure is released thereby releasing the brakes 19. Hence, when the trailer 14 is parked and pressurized air present in the park brake line 13 is exhausted to atmosphere, the park brake control valve 18 exhausts the air from the brakes 19 thereby allowing the mechanical spring force to be reapplied to the brake 19, such that the brakes 19 become applied. The trailer park brakes 19 becoming released only through pressuring the park brake line 13 so the park brake control valve 18 can pressurize the spring loaded brake cylinder to release the brakes 19.

While such a conventional air brake arrangement is an effective safety development that provides an air brake system that is locked when the compressed air supply to the trailer 14 is exhausted to atmosphere or at zero pressure; in order to access the trailer 14 all that is required is to connect the trailer 14 to a compressed air source, such as any tractor's brake system, and the trailer can be moved. Hence, such a simple means for overriding the brakes 19 makes security of the trailer 14 problematic. This is particularly a problem when a trailer 14 together with its cargo is parked (with or without the tractor), as it is susceptible to theft by the simple means of pressurizing the supply line to release the park brakes 19, which can be achieved by simply connecting a tractor or the like to the trailer.

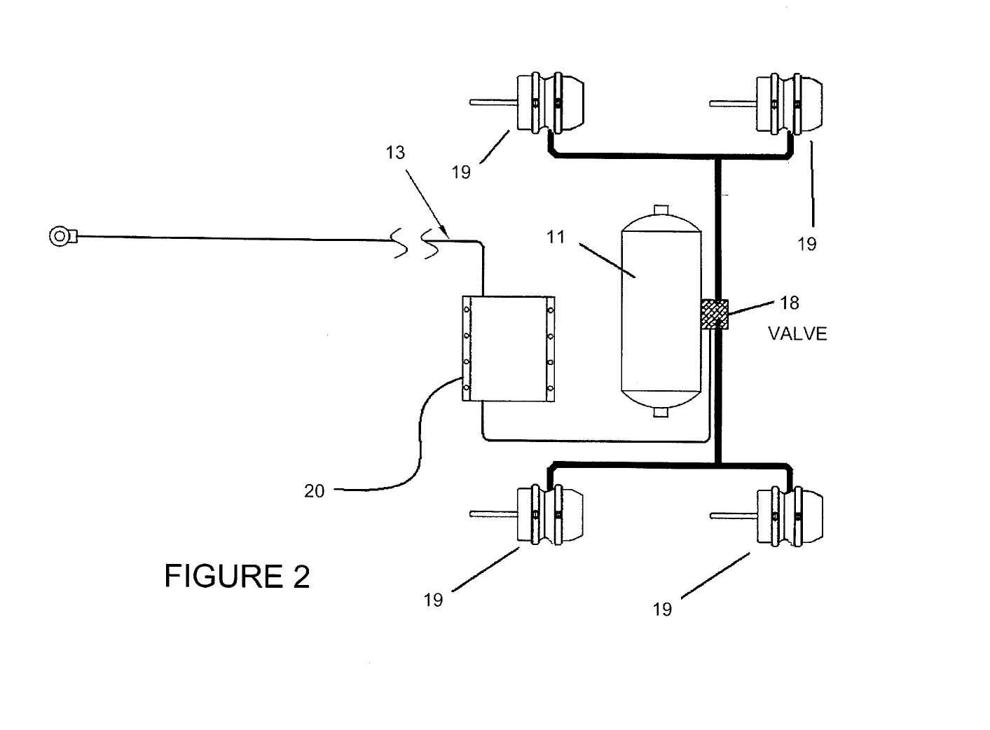

Whilst merely providing a blocking means in the park brake line 13 to prevent supply of pressurized air to the park brake control valve 18 may achieve a degree of security, this has a potential to introduce significant safety problems. Blocking the supply line 13 will ensure the pressurized air does not pass through the blocking device, but this means the air line between the blocking device and the park brake control valve 18 will also be blocked. As is shown in FIG. 2, with conventional air braking systems, compressed air storage tanks 11 are typically provided to store a supply of compressed air for use with the vehicle's service braking system. Such a source of compressed air is also connectable to the park brake control valve to control the actions of the brakes 19 when the vehicle is in motion. It has been found that when a vehicle is parked and the brakes 19 are in action, it is possible for the park brake valve 18 to leak pressurized air from the connected air tank 11 back into the supply air line 13. If the supply line 13 is merely blocked to prevent unauthorized connection of a compressed air source to the park brake valve of the trailer, the air line 16 connecting the blocking device and the park brake valve will be closed and may allow a build up of pressurized air to form therein. This can unintentionally cause the valve 18 to release the park brakes 19 of the vehicle 10, creating a potential safety risk to the vehicle and its surroundings. Hence, merely diverting or blocking the supply of compressed air into the supply line 13 of the trailer 14 is not enough to address safety concerns, hence a device that addresses security issues and safety concerns needs to also exhaust the delivery out of the supply line downstream of any blocking device.

To address this problem an isolator assembly 20 in accordance with the present invention is employed in the park brake line 13, as shown in FIGS. 1 and 2. The isolator assembly 20 functions to independently lock the vehicle park brake system and prevent the driver from moving the vehicle 10 and also has the capability to safely slow down a vehicle in motion from a remote location by gradually applying the vehicle park brakes to bring the vehicle 10 to a stop.

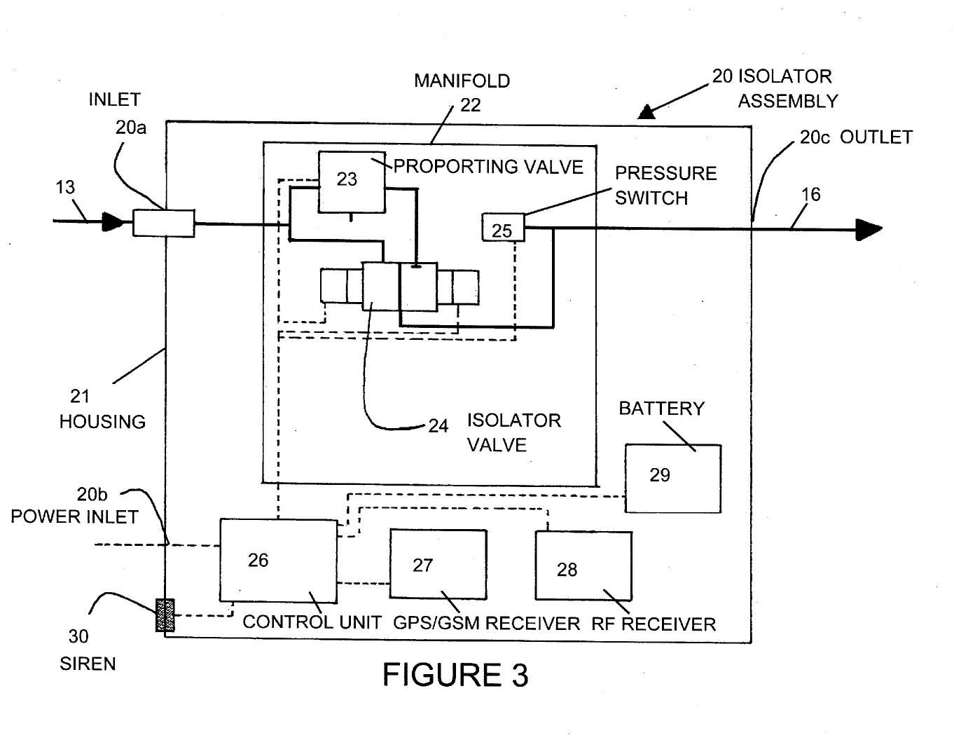

The isolator assembly 20 is shown in isolation in FIG. 3. The isolator assembly 20 is contained within a housing 21 which is configured to be mounted to the vehicle 10. In the embodiment as shown in FIG. 1, the isolator assembly is configured to be mounted to the trailer 14 of the vehicle, however the location of the isolator assembly may vary in accordance with the type of vehicle it is to be employed with.

The housing 21 of the isolator assembly comprises an inlet 20a that is connectable to the supply line 13 of the park brake circuit so as to receive a source of compressed air. The housing also comprises a power inlet 20b which is connectable to a power supply source of the vehicle, namely an external battery or alternator that can function as a source of power for the isolator assembly 20. The housing also comprises an outlet 20c through which compressed air can pass between the isolator assembly 20 and the supply line 16 located between the isolator assembly and the brakes 19.

The housing 21 houses a pneumatic manifold 22 which is connected between the inlet 20a and the outlet 20c and which controls the flow of compressed air within the supply line 13. The pneumatic manifold 22 generally comprises an isolator valve 24 that is controllable so as to be placed in either an open or a closed state. The isolator valve 24 functions to direct the flow of compressed air in the supply line in accordance with the desired state of the isolator assembly 20, in a manner which will be discussed in more detail below. The isolator valve 24 is preferably a solenoid valve, but other types of valves may also be used.

The pneumatic manifold 22 also comprises a pressure proportioning valve 23 that is in fluid communication with the inlet 20a and the isolator valve 24. The pressure proportioning valve 23 essentially functions to control the pressure of the output supply line 16, in a manner to be discussed in more detail below. A pressure switch 25 is also provided within the pneumatic manifold 22 to further provide a means of controlling the output pressure of the pressure proportioning valve 23.

It will be appreciated that the pneumatic manifold 22 is configured to handle the flow of fluid, namely compressed air, within the supply line 13. In order to control the operation of the overall isolator assembly 20, a control unit 26 is provided. The control unit 26 is housed within the housing 21 of the assembly 20 and manages the overall process. In this regard, the control unit 26 receives and processes a variety of signals that enable it to determine when to lock/unlock the brake system as well as to continually monitor the status of the brake system, in a manner as will be described in more detail below. To provide data and power to the control unit 26, a GPS/GSM receiver 27 is provided as well as an RF receiver 28. Such receivers enable the isolator assembly 20 to be controlled remotely. A rechargeable battery 29 is also provided within the housing 21 to provide power to the components of the isolator assembly 20. The provision of battery 29 enables the isolator assembly to function in the absence of an external power supply, such as when a trailer 14 is detached from a tractor 12. A rechargeable battery is required on trailer systems where it does not have its own battery power supply. However, when the isolator assembly is installed in a tractor unit, a rechargeable battery may not be required as the system may utilize the main battery located in the tractor.

In a preferred embodiment, when a driver of a vehicle activates the vehicle park brakes, the control unit 26 of the isolator assembly 20 detects such a condition and activates the isolator assembly to lock the vehicle park brake system.

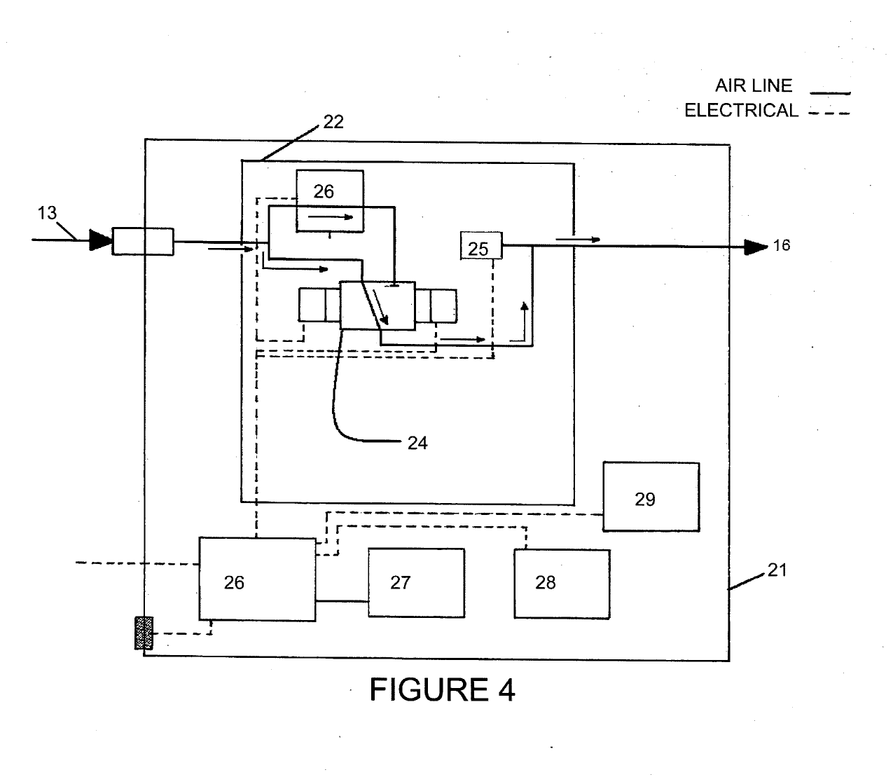

As is shown in FIG. 4, when the vehicle 10 is in use or is in a mobile situation, the isolator assembly 20 is largely inactive, as the park brakes 19 are not required. In this regard, the supply line 13 is in communication with a constant source of pressurized air which is received by the isolator valve 24 which is an open state, as shown. This enables a supply of compressed air to be delivered through line 16 to the air tank 11 for use by the service brakes. In such an open state, the compressed air is permitted to travel through the isolator valve 24 and into supply line 16, where it is received by the park brake valve 18, to retain the brakes 19 in a disengaged manner (as is shown by the arrows).

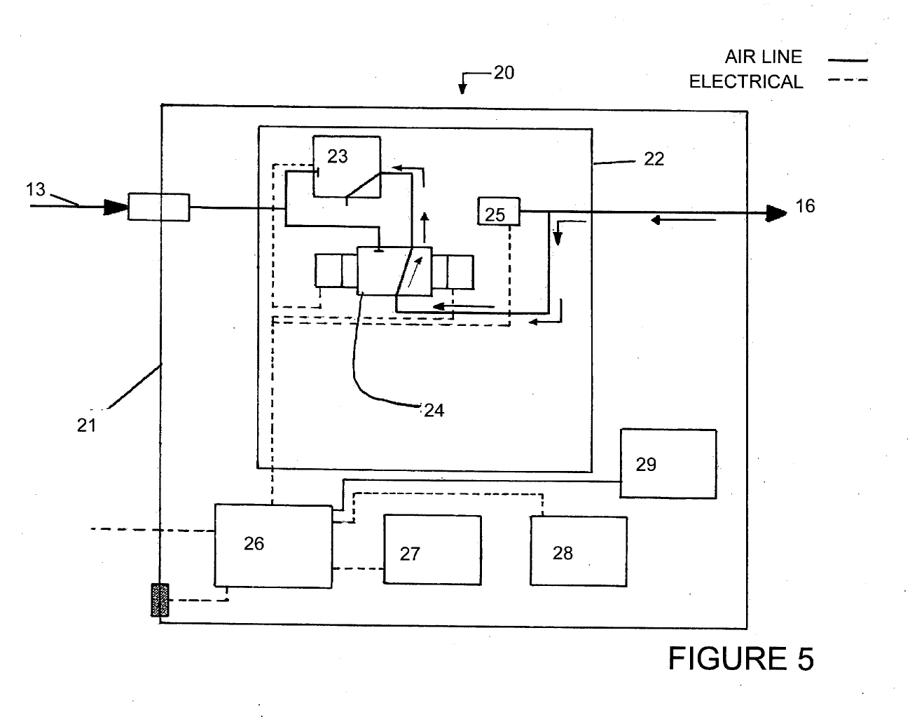

When the control unit 26 receives a signal indicating that the vehicle's park brakes have been activated, the control unit 26 then sends a signal to the isolator valve 24 to close the isolator valve, as shown in FIG. 5. In the closed state, the isolator valve 24 blocks the flow of compressed air from the supply line 13. Any pressurized air present in the air line 16 downstream of the pneumatic manifold 22 is able to flow in the direction of the arrows through the isolator valve 24 and into the pressure proportioning valve 23, where it is exhausted or vented into the atmosphere, as shown.

The venting of the air line 16 is an important safety feature of the isolator assembly 20 of the present invention. This is controlled by the control unit 26, which receives data from the pressure switch 25 that indicates the presence, or otherwise, of pressurized air in the air line 16. Upon the pressure switch 25 sensing such a condition, the control unit 26 places the pressure proportioning valve 23 into an exhaust or venting state thereby allowing for the bleeding of air in the air line 16. It will be appreciated that the control unit 26 may retain the pressure proportioning valve 23 in such a state or, upon the pressure switch 25 indicating that the air pressure in the air line 16 is below a predetermined level, the pressure proportioning valve 23 may be returned to a closed state, or a state whereby supply line 13 is exhausted or vented into the atmosphere.

The control unit 26 may actively monitor the overall status of the braking system of the vehicle through the pressure switch 25. This can be done whether the vehicle is in motion or stationary. In this regard, the isolator assembly 20 of the present invention also has the functionality to safely slow down a moving vehicle, should such a need arise. This may be required to disable a stolen vehicle or to assist a driver in bringing a vehicle to an emergency stop in a safe and controlled manner.

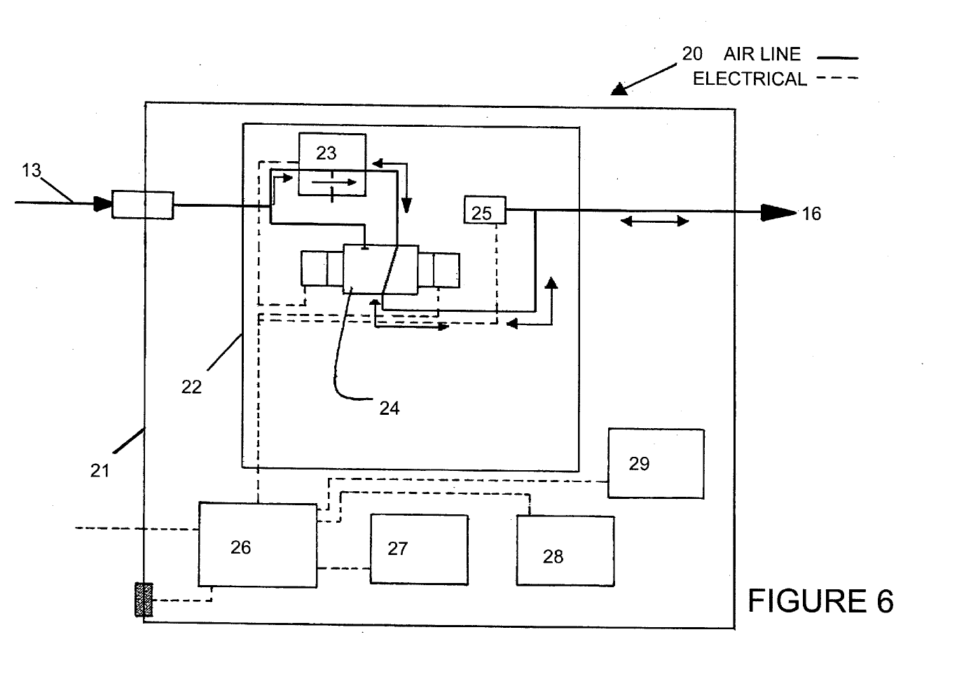

In the case of a stolen vehicle being detected, a signal from a central agency or the like may be transmitted whereby it is received by the GPS/GSM receiver 27. The signal is then processed by the control unit 26 which sends a signal to the isolator valve 24 to move the isolator valve 24 into a closed position, as is shown in FIG. 6. In this position the pressurized air in the supply line 13 is caused to pass through the pressure proportioning valve 23 and through the isolator valve 24 such that the brakes 19 are not suddenly initiated, which may cause the vehicle to suddenly stop and lose control. Hence, as is shown by the arrows in FIG. 6, air supply to the supply line 16 is still achieved.

However, in this situation the control unit 26 is able to determine the air pressure in the air line 16 through the pressure switch 25 and, based upon the state of the pressurized air present in the air line 16, is able to control the pressure proportioning valve 23 so as to cause the pressure proportioning valve 23 to vent or exhaust air into the atmosphere in a gradual manner to slow down the vehicle. As the pressure proportioning valve 23 controls the pressure of the air output to the air line 16 and ultimately to the park brake valve 18, the vehicle can be gradually slowed down whilst the driver has full control of the vehicle steering and the service brake system.

Once the vehicle has been brought to a halt, the control unit 26 can then transmit data to an appropriate central receiving point as to the global position of the vehicle for retrieval purposes and the like.

In the embodiments of the invention as described above, the isolator assembly 20 provides a means of automatically isolating (locking) a vehicle (e.g. tractor or trailer) by utilizing its air brake system. The isolator assembly 20 automatically locks the vehicle park brake system whenever the vehicle park brakes are applied. In order to prevent unauthorized access of the vehicle, the isolator assembly is configured to only unlock the park brake system of the vehicle via an authorized remote control keyfob transmitter, or similar device. Such a transmitter may be carried by an authorized driver, or similar authorized officer, which, when activated sends an RF signal to the receiver 28 which is processed by the control unit 26 to unlock the brake system. The radio frequency signal transmitted by the keyfob or similar device carried by the driver is coded for the particular system.

The isolator assembly 20 can also be operated from a remote location using telecommunication networks. This form of operation can be used to both lock and unlock the isolator assembly so that, for example, if a prime mover/trailer is stolen whilst the system is unlocked, then the remote operation can lock the brakes on the vehicle. Also, if the vehicle is parked with a group of vehicles 10 operated by a single operator, such as may be the case in a large logistics or transport freighting organization, the individual isolator assemblies can be controlled by a dispatcher or the like who can permit individual vehicles to be unlocked and driven by persons other than the person carrying to keyfob transmitter so that they can readily be loaded and unloaded as required.

It will be appreciated that the control unit 26 of the isolator assembly 20 is in the form of a computer device having programmable and/or non-programmable memory so as to provide multiple functions in the overall management of the device. In particular, the control unit 26 determines when to lock and unlock the brake system; monitors the ongoing status of the brake system via a pressure switch 25 and provides corrective action where necessary; and recharges the battery 29 when external power to the housing 21 is present. The control unit 26 also isolates the battery 29 when battery voltage has fallen below a specified voltage to ensure the longevity of the battery and electrically protects the system from common electrical issues that relate to truck systems, e.g. short-circuit, over voltage, over current, transient voltage and reverse polarity.

During use the control unit 26 also acts to signal the GPS/GSM device 27 that the external power is available, and receives commands from the GPS/GSM device 27 for controlling the vehicle brakes from a remote location.

As referred to in FIG. 3, the isolator assembly 20 also includes a siren 30 that has an ability to emit an audible sound. In this regard, in the event of unauthorized access or an abnormal operating situation, the control unit 26 can send an appropriate signal to the siren 30 to issue an appropriate sound to alert authorities in the immediate vicinity of the vehicle of a situation, or to alert the driver of the status of the system.

It will be appreciated that whilst the isolator assembly of the present invention has been described as being enclosed within a single housing 21, it will be appreciated that the assembly can be installed onto a vehicle as individual components and still fall within the spirit of the present invention.

The present invention provides a system and method for controlling the supply of air to a pneumatic brake system of a vehicle. When the system is in an unlocked state compressed air is permitted to pass through the supply line to the brake system, whilst when the system is a locked state, compressed air is blocked from passing the isolator assembly and any compressed air present downstream of the isolator assembly is exhausted into the atmosphere. Such an arrangement is initiated automatically when a vehicle is parked by the driver and grandly enhances the overall security of the vehicle and any cargo it may be carrying, as well as the safety of the parked vehicle.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

Orientational terms used in the specification and claims such as vertical, horizontal, top, bottom, upper and lower are to be interpreted as relational and are based on the premise that the component, item, article, apparatus, device or instrument will usually be considered in a particular orientation, typically with the device uppermost.

It will be appreciated by those skilled in the art that many modifications and variations may be made to the methods of the invention described herein without departing from the spirit and scope of the invention.

1. A control system for a vehicle having an air braking system comprising:
a supply line for receiving a supply of compressed air for use in the air braking system; one or more brake members in fluid communication with the supply line and controllable such that upon receipt of a supply of compressed air the one or more brake members become disengaged so as to facilitate movement of the vehicle and upon removal of the supply of compressed air the one or more brake members become engaged so as to prevent movement of the vehicle; and
an isolator device positionable within the supply line so as to be located upstream of said one or more brake members, the isolator device being controllable to operate in at least two states, a first state wherein the compressed air is permitted to flow along said supply line to the one or more brake members and a second state wherein the compressed air is prevented from flowing along said supply line to the one or more brake members;
wherein when said isolator device is in the second state, any compressed air present in the supply line downstream of the isolator device but upstream of the one or more brake members is exhausted therefrom.

2. The control system according to claim 1, wherein the isolator device comprises an inlet connectable to the supply line so as to be in fluid communication with the supply of compressed air, and an outlet in fluid communication with the one or more brake members.

3. The control system according to claim 1, wherein the isolator device comprises a pneumatic manifold that is controllable to place said isolator device in said first or second state.

4. The control system according to claim 3, wherein the pneumatic manifold comprises an isolator valve that is movable between an open and a closed position.

5. The control system according to claim 4, wherein when the isolator valve is in the open position the isolator device is in the first state and compressed air is able to pass therethrough from the inlet to the supply line downstream of the isolator device, and when the isolator valve is in the closed position the isolator device is in the second state and compressed air is prevented from passing therethrough directly from the inlet.

6. The control system according to claim 4, wherein the pneumatic manifold further comprises a pressure proportioning valve in fluid communication with the isolator valve.

7. The control system according to claim 6, wherein the pressure proportioning valve is controllable to facilitate exhausting or venting of compressed air from the isolator device.

8. The control system according to claim 7, wherein the pressure proportioning valve is controllable so as to be placed in an open state that facilitates flow of compressed air therethrough, and a closed state that facilitates exhausting or venting of compressed air therefrom.

9. The control system according to claim 5, wherein the pneumatic manifold further comprises a pressure switch in fluid communication with the outlet of the isolator device to facilitate monitoring of the pressure of air present in the supply line downstream of the isolator device.

10. The control system according to claim 9, wherein when the isolator device is in the second state and the control switch detects the presence of compressed air in the supply line downstream of the isolator device, the pressure proportioning valve is placed in a closed state to facilitate exhausting or venting of said compressed air therefrom through said isolator valve.

11. The control system according to claim 10, wherein each of the control switch, pressure proportioning valve and the isolator valve are controllable by a programmable controller.

12. The control system according to claim 11, wherein the programmable controller is a computer device housed within the isolator device.

13. The control system according to claim 1, wherein the vehicle comprises a tractor and a detachable trailer, wherein the supply of compressed air is an air compressor provided on the tractor.

14. The control system according to claim 13, wherein the one or more brake members are park brakes provided on the detachable trailer.

15. An isolator device for a vehicle having an air braking system comprising:
an inlet for receiving a supply of compressed air;
an outlet for delivering a supply of compressed air to an air braking system positioned downstream of the isolator device;
a pneumatic manifold controllable so as to regulate the supply of compressed air to air braking system positioned downstream of the isolator device and from the air braking system downstream of the isolator device; and
a controller for controlling the pneumatic manifold.

16. The isolator device according to claim 15, wherein the pneumatic manifold comprises an isolator valve movable between an open position and a closed position.

17. The isolator device according to claim 16, wherein when the isolator valve is in the open position compressed air is able to pass therethrough from the inlet to the air braking system downstream of the isolator device top engage the air braking system.

18. The isolator device according to claim 16, wherein when the isolator valve is in the closed position compressed air is prevented from passing therethrough directly from the inlet.

19. The isolator device according to claim 16, wherein the pneumatic manifold further comprises a pressure proportioning valve in fluid communication with the isolator valve.

20. The isolator device according to claim 19, wherein the pressure proportioning valve is controllable to facilitate exhausting or venting of compressed air therefrom.

21. The isolator device according to claim 20, wherein the pressure proportioning valve is controllable so as to be placed in an open state that facilitates flow of compressed air therethrough, and a closed state that facilitates exhausting or venting of compressed air therefrom.

22. The isolator device according to claim 18, wherein the pneumatic manifold further comprises a pressure switch in fluid communication with the air braking system positioned downstream of the isolator device to facilitate monitoring of the pressure of air present therein.

23. The isolator device according to claim 22, wherein when the isolator valve is in a closed position and the control switch detects the presence of compressed air in the air braking system positioned downstream of the isolator device supply line, the pressure proportioning valve is placed in a closed state to facilitate exhausting or venting of said compressed air therefrom through said isolator valve.

24. The isolator device according to claim 15, wherein the controller is a computer programmable controller.

25. A method of controlling an air braking system of a vehicle comprising:
detecting the vehicle being placed in a parked condition, the vehicle having an isolator device including an inlet for receiving a supply of compressed air, an outlet for delivering a supply of compressed air to an air braking system positioned downstream of the isolator device, a pneumatic manifold controllable so as to regulate the supply of compressed air to air braking system positioned downstream of the isolator device and from the air braking system downstream of the isolator device, and a controller for controlling the pneumatic manifold;
activating the isolator device to prevent unauthorized delivery of compressed air to the air braking system of the vehicle to release brakes of the air braking system; and
monitoring the air braking system to detect the presence of compressed air therein; and deactivating the isolator device upon receipt of an authorized signal.

26. The method according to claim 25, wherein the step of detecting the vehicle being placed in a parked condition comprises sensing the state of the vehicle park brakes and generating a signal when the park brakes of the vehicle have been activated by a driver of the vehicle.

27. The method according to claim 25, wherein the step of activating the isolator device comprises placing the isolator valve of the isolator device in a closed position.

28. The method according to claim 25, wherein the step of monitoring the air braking system comprises detecting the state of the pressure switch of the isolator device and upon the pressure switch detecting the presence of compressed air in the air braking system placing the pressure proportioning valve in a closed state to facilitate exhausting or venting of said compressed air therefrom through said isolator valve.

29. The method according to claim 25, wherein the step of deactivating the isolator device comprises receiving a deactivation signal from a source and checking the authenticity of the deactivation signal from an authentification source.

30. The method according to claim 25, wherein the step of deactivating the isolator device comprises receiving a deactivation signal from a source and checking the authenticity of the deactivation signal from an authentification source.

31. The method according to claim 25, wherein the authenticity of the deactivation signal is checked by reference to an database of authentic signals stored internally of the isolator device or accessed by the isolator device remotely.
